(19) United States
(12) Patent Application Publication
(10) Pub. No.: US 2004/0047997 A1
(43) Pub. Date: Mar. 11, 2004

(54) Method for rendering surfaces resistant to soiling

(76) Inventors: Harald Keller, Ludwigshafen (DE); Ekkehard Jahns, Weinheim (DE); Christian Lach, Bad Durkheim (DE); Stephan Huffer, Ludwigshafen (DE); Elmar Stockelmann, Grunstadt (DE); Yi Thomann, Umkirch (DE); Thomas Frechen, Heidelberg (DE)

Correspondence Address: KEIL & WEINKAUF, 1350 CONNECTICUT AVENUE, N.W., WASHINGTON, DC, 20036, US

(21) Appl. No.: 10/451,745

(22) PCT Filed: Jan. 10, 2002
(86) PCT No.: PCT/EP02/00166

(30) Foreign Application Priority Data
Jan. 12, 2001 (DE) 101 01 162.8

(51) Int. Cl. B05D 1/36

(52) U.S. Cl. 427/402

(57) ABSTRACT

Surfaces are provided with a dirt-repellent treatment by a process in which the surfaces are coated with particles which have a mean diameter of from 3 nm to 5 μm and consist of a material which has a surface energy of at least 20 mN/m.

The present invention relates to a process for the dirt-repellent treatment of surfaces, which comprises coating the surfaces with particles which have a mean diameter of from 3 nm to 5 μm and consist of material which has a surface energy of at least 20 mN/m and is selected from organic polymers and copolymers and solid inorganic oxides, carbonates, phosphates, silicates or sulfates of groups 3 to 14 of the Periodic Table.

Settled and caked deposits in apparatuses and apparatus parts for plant construction represent a serious problem in industry, especially in the chemical industry. They particularly affect apparatus, container and reactor walls, kettle walls, discharge apparatuses, valves, pumps, filters, compressors, centrifuges, columns, dryers, centrifugal separators, scrubbers, comminution machines, internals, packings, heat exchangers, evaporators, condensers, nozzles, atomizers, spray dryers, crystallizers, filling lines and mixing elements. These deposits are also referred to as coatings or fouling.

These coatings may have a variety of damaging or hindering effects for the process and may make it necessary to shut down and clean corresponding reactors or processing machines repeatedly.

Measurement apparatuses encrusted with coatings may lead to incorrect or misleading results, through which operating errors may occur.

Coatings are disadvantageous in other applications too. After wetting and evaporation, water leaves behind residues on surfaces, for example rainwater on window panes, motor vehicles, traffic signs or billboards. Through wetting, flowing liquids cause friction against the surfaces on which flow occurs. This leads to friction losses, for example in the case of ships, but also in the case of liquids which flow through pipelines.

Through wetting, liquids, e.g. emulsions, suspensions or polymer dispersions, can cause coatings and deposits in the interior of process apparatuses, for example pipes, kettles, tanks, reactors, heat exchangers, evaporators, condensers, pumps, nozzles, atomizers, spray dryers, crystallizers or filling lines and laboratory apparatuses.

Electrical apparatuses and components in areas exposed to weathering and in areas not exposed to weathering but in contact with ambient air become soiled on their surfaces. As a result of the soiling itself and in particular through moistening of the dirt, for example by rain, mist or atmospheric humidity, the surfaces acquire a certain degree of electrical conductivity, resulting in leakage currents which may impair the operation of the components. Furthermore, considerable energy losses occur as a result of soiling of isolators, for example in the case of high-voltage overhead lines and voltage-conversion apparatuses. Moreover, the dirt is often the cause of corrosion of the structural apparatuses and the substrate for additional biological contamination by, for example, microorganisms, algae, lichens, mosses or mussels.

As a result of the wetting (moistening), undesired life forms, for example microorganisms, biofilms, algae, lichens, mosses or mussels, can grow on surfaces, for example roofs, facades, shower cubicles, ships or heat exchangers.

As a result of wetting, liquids and liquid-containing materials, for example milk, honey, yoghurt or toothpaste, remain partly adhering to the inner surface of the packaging materials. Consequently, a part of the packaging material cannot be used unless it is cleaned by an expensive procedure. Furthermore, the recycling of packaging materials is difficult owing to contamination with the content. Finally, the decay of perishable residue also constitutes a hygiene problem and leads, particular in summer, to unpleasant odors in the vicinity of garbage cans.

If solid surfaces come into contact with particles, adhesion occurs. The adhesion of particles, for example dirt, dust, soot, industrial powders, pollen, spores, bacteria or viruses, leads to contamination of the surfaces and-is undesirable in many cases.

A further problem which arises as a result of the formation of deposits lies in the fact that, especially in coatings in polymerization reactors, the molecular parameters such as molecular weight or degree of crosslinking differ significantly from the product specifications. If deposits become detached in the course of ongoing operation, they may contaminate the product (for example, specks in paints, inclusions in suspension beads). In the case of reactor walls, packings or mixing elements, unwanted deposits may lead, furthermore, to an unwanted change in the residence time profile of the apparatus or may impair the efficiency of the internals or mixing elements as such. Fairly coarse sections of coatings which break off may lead to blockage of discharge and processing devices, while small parts may result in impairment of the product produced.

The deposits whose formation is to be prevented are coatings which may be caused, for example, by reactions with and on surfaces. Further reasons include adhesion to surfaces, which may be caused by van der Waals forces, polarization effects or electrostatic double layers. Other important effects are stagnation of movement at the surface and possible reactions in said stagnating layers. Finally, mention may be made of the following: precipitates from solutions, evaporation residues, cracking on locally hot surfaces, and microbiological activity.

The causes are dependent on the respective combinations of material and may act alone or in combination. While the processes resulting in the unwanted coatings have been investigated quite well (for example A. P. Watkinson and D. I. Wilson, Experimental Thermal Fluid Sci. 1997, 14, 361 and literature cited therein), the schemes for preventing the above-described deposits are lacking in uniformity. The processes known to date have technical disadvantages.

Mechanical solutions have the disadvantage that they may give rise to considerable additional costs. Additional reactor internals may, furthermore, significantly alter the flow profile of fluids in the reactors and as a result may necessitate an expensive redevelopment of the process. Chemical additives may lead to unwanted contamination of the product; some additives pollute the environment.

For these reasons, there is an increased impetus to the search for ways of directly reducing the fouling tendency by modification of apparatuses and apparatus parts for chemical plant construction.

EP-A 0 745 568 discloses the possibility of imparting water repellency to surfaces through fluorinated, and especially perfluorinated, alkylsilanes. These subtances, however, are comparatively expensive.

WO 00/40775, WO 00/40774 and WO 00/40773 describe processes for coating surfaces, especially surfaces of reactors for high-pressure polymerization of 1-olefins or surfaces of heat exchangers, by electroless deposition of an NiP/polytetrafluoroethylene layer or a CuP/polytetrafluoroethylene layer by means of which the metal surfaces in question can be antiadhesively modified. When the surfaces coated by the process described are used in apparatuses and apparatus parts for chemical plant construction, especially reactors for the high-pressure polymerization of 1-olefins, however, it is observed that the surfaces are not sufficiently mechanically stable, so that following prolonged use caked deposits of product are again observed. It is, however, impossible to recoat an NiP/polytetrafluoroethylene layer which has been worn down only partially. Moreover, it is observed that an NiP/polytetrafluoroethylene layer, once deposited, is difficult to remove again if it is no longer desired in a reactor or apparatus part. Especially in reactors with rapid product change, in which occasionally reactions are to be carried out at above 400° C., a coating with NiP/polytetrafluoroethylene has been found inappropriate. A final disadvantage is that, especially when coating reactors of high volume, it is necessary to use large amounts of dipping baths, leading to considerable solvent wastes.

WO 96/04123 discloses self-cleaning surfaces which may be coated with polytetrafluoroethylene and have particularly hydrophobic properties. The structuring is brought about by incipient etching or embossing of the surface, by physical methods such as sandblasting or ionic etching using, for example, oxygen. The spacing of the elevations or indentations is more than 5 μm. Subsequently, the surface is coated with Teflon. The mechanical stability of coats hydrophobicized in this way, however, is much too low for use in chemical apparatus construction, especially for polymerization reactors, where strong shear forces act. However, the layers thus applied are not sufficiently transparent for many applications.

Furthermore, structured surfaces having hydrophobic properties are known (EP-A 0 933 388) which are prepared by, for example, incipiently etching the surface in question, thus producing elevations or grooves less than 10 μm apart, on the surface and subsequently covering them with a layer of a hydrophobic polymer, polyvinylidene fluoride for example, the surface energy of the corresponding material being less than 20 mN/m. These coats may further comprise fluorinated waxes, examples being Hostaflone®. The surfaces modified in this way are hydrophobic and oleophobic. Applications cited include wafer mounts in semiconductor production, and also the preparation or coating of headlamps, windscreens or solar cell covers. A disadvantage of the process, however, is that, following partial mechanical breakdown, the structuring is difficult to renew.

DE 198 60 139 C1 discloses a process for producing an ultraphobic surface by coating surfaces with Ni(OH)₂ prepared by a selected method and then hydrophobicizing it. As adhesion promoters, the use of noble metal films, Ag or Pt for example and Au in particular, is recommended. The process disclosed, however, is expensive and comparatively complicated.

Finally, DE-A 100 22 246 (published on . . . ) discloses a coating material which contains a finely divided powder and a binder. A solvent is always required for applying a binder, which is undesirable in many cases.

It is an object of the present invention

to provide a process for the dirt-repellent treatment of surfaces which avoids the disadvantages stated in the prior art and contains no binder,

to provide dirt-repellent surfaces

and to provide uses for articles having dirt-repellent surfaces.

We have found that this object is achieved if the surfaces to be provided with the dirt-repellent treatment are coated with particles which have a mean diameter from 3 nm to 5 μm and consist of a material which has a surface energy of at least 20 mN/m.

The novel process comprises a plurality of steps.

In the first step, the surface to be provided with the dirt-repellent treatment is prepared by rendering it tacky prior to the coating step, so that the particles to be applied according to the invention are fixed. This can be effected by a plurality of alternative steps:

A primer which performs the function of an adhesive can be applied. Suitable primers are, for example, polymer dispersions, such as ethylene/acrylic acid copolymers which have been partially neutralized with ammonia or amines; a particularly preferred example is Lugalvan DC® from BASF AG; or Acronal® V 210 as a particularly preferred example of an adhesive. Furthermore, hotmelt adhesives and fusible polymers, for example polyethylene, polypropylene, polystyrene, polyoctadecyl vinyl ether or polyvinyl chloride, are suitable. Waxes, such as polyethylene waxes, polypropylene waxes, carnauba waxes, montan waxes or paraffin waxes, are also suitable as primers. The thickness of the adhesive layer to be applied is not critical for the novel process and may be from 0.1 μm to 10 mm.

Alternatively, where the surface to be provided with the dirt-repellent treatment comprises plastics, said surface may also be heated for a short time to a temperature which is above the glass transition temperature of the relevant plastic, or partially dissolved or swelled with a solvent.

The surfaces to be provided with the dirt-repellent treatment is then coated with particles which have a mean diameter of from 3 nm to 5 μm and consist of a material which has a surface energy of at least 20 mN/m. The particles to be applied are characterized by their hydrophobic surface, their porous structure and their mean diameter.

The porous structure can be best characterized by the BET surface area, measured according to DIN 66131. The particles used have a BET surface area of from 5 to 1000, preferably from 10 to 800, particularly preferably from 20 to 500, m²/g.

The particles consist of a material which has a surface energy of 20 mN/m or more. Suitable materials are organic polymers, for example polyethylene, polypropylene, polyisobutylene and polystyrene and copolymers thereof with one another and with one or more further olefins, for example styrene, methyl acrylate, ethyl acrylate, methyl methacrylate, butyl acrylate, butyl methacrylate, 2-ethylhexyl acrylate, 2-ethylhexyl methacrylate, maleic anhydride or N-methylmaleimide. A preferred polyethylene or polypropylene is described, for example, in EP-A 0 761 696.

Further suitable materials are solid inorganic oxides, carbonates, phosphates, silicates or sulfates of groups 3 to 14 of the Periodic Table of the Elements, for example calcium oxide, silica or alumina, calcium carbonate, calcium sulfate or calcium silicate, alumina and silica being preferred. Silica in its modification as silica gel is particularly preferred. Pyrogenic silica gels, which are commercially available, for example, as Aerosil® grades from Degussa-Hüls, are very particularly preferred. The solid inorganic oxides can be rendered hydrophobic thermally by heating to 400 to 800° C. and preferably by physisorbed or chemisorbed organic or organometallic compounds. For this purpose, the particles are reacted, prior to the coating step, with organometallic compounds which contain at least one functional group, for example alkyllithium compounds, such as methyllithium, n-butyllithium or n-hexyllithium; or silanes, for example hexamethyldisilazane, octyltrimethoxysilane, trimethylchlorosilane or dichlorodimethylsilane.

The mean diameter of the particles is from 3 nm to 5 μm, preferably from 5 nm to 1 μm, particularly preferably from 7 nm to 0.5 μm.

If desired, the surfaces to be provided with the dirt-repellent treatment can be coated with mixtures of particles comprising two or more different materials.

The mixing ratios can be chosen within wide ranges, but it should be ensured that the particles of that material which has a surface energy of more than 20 mN/m is present in an amount of more than 50, preferably more than 75, % by weight of the particles.

The particles described above are applied to the surface to be provided with the dirt-repellent treatment. This application is also referred to as coating. The coating is effected without liquid dispersants. In one embodiment of the novel process, a workpiece to be coated is dusted with the particles described above. This process is particularly suitable for flat surfaces, for example of films.

In another embodiment of the present invention which is particularly suitable for internal surfaces of apparatuses or containers, the apparatus or container is completely or partly filled with the particles, sufficient convection is ensured and the non-adhering particles are then removed.

The coating step can be repeated if desired.

By means of the novel process, the surfaces to be provided with the dirt-repellent treatment are coated with a particle layer whose thickness is from 3 nm to 10 μm, preferably not more than 1 μm, particularly preferably from 5 nm to 0.3 μm.

After the coating the coat is allowed to age before the articles having the surfaces coated according to the invention are used. This aging may take from 20 minutes to about 10 hours, preferably from 1 to 3 hours. The aging can be carried out at room temperature or at slightly elevated temperatures; however, the temperature should be sufficiently high for the particles or primer to begin to sinter. It has been found that a temperature of from 20 to 50° C. is sufficient in many cases.

The choice of the materials of the surfaces to be provided with the dirt-repellent treatment is not critical. For example, polymers, such as polyethylene, polypropylene, polystyrene, polyesters, Plexiglas, polyamides, polycarbonates or polyurethanes are suitable, as well as metals and alloys, for example silver, palladium, platinum, steels, copper or nickel, and paper, board, textile, stone, ceramic, concrete, porcelain, glass or wood. Transparent materials, for example glass, Plexiglas and polycarbonates of the Makrolon® grades, are particularly suitable.

The present invention furthermore relates to surfaces provided with the dirt-repellent treatment by the process described above. They can be extremely easily cleaned by simply rinsing with, for example, water; in contrast to the surfaces described in the prior art, no addition of surfactants is necessary. Furthermore, the surfaces according to the invention are highly transparent.

The surfaces have proven particularly dirt-repellent with respect to the following media: water, coffee, honey, glycerol, 32% strength by weight aqueous hydrochloric acid, 5% strength by weight aqueous sodium hydroxide solution, 30% by weight aqueous solution of polyacrylic acid, 30% strength by weight aqueous solution of a copolymer consisting of vinylpyrrolidone and vinylimidazole, aqueous polymer dispersion Acronal® 290 D (BASF AG) and aqueous polymer dispersion Styronal® D 808 (BASF AG).

The present invention furthermore relates to pipes and pipelines having surfaces which have been provided with the dirt-repellent treatment by the process described above. They are particularly suitable for pumping through solutions because, owing to the surfaces provided with the dirt-repellent treatment, no deposits form and hence the resistance to flow remains low. Pipelines comprising glass, Plexiglas or polycarbonate and having surfaces provided with the dirt-repellent treatment by the novel process are particularly preferred.

The present invention furthermore relates to vessels, for example cups or glasses, and packaging having surfaces provided with the dirt-repellent treatment. Liquids of all kinds, including highly viscous liquids, for example mineral water, lemonade, cola, juices, beer, wine, coffee, milk, honey, yoghurt or toothpaste, can be poured from the novel cups, glasses and other-vessels without leaving a residue.

The present invention furthermore relates to motor vehicles, for example automobiles or ships, having no tendency to icing or soiling, which have surfaces provided with the dirt-repellent treatment by the novel process.

The present invention furthermore relates to apparatuses or apparatus parts, in particular for chemical plant construction, for example apparatus, container and reactor walls, discharge apparatuses, fittings, pumps, filters, compressors, centrifuges, columns, dryers, centrifugal separators, scrubbers comminution machines, internals, packings, heat exchangers, evaporators, condensers, nozzles, atomizers, spray dryers, crystallizers, filling lines and mixing elements, containing one or more novel dirt-repellent surfaces. Inspection windows having surfaces treated by the novel process are very particularly preferred. No caked or settled deposits are observed on these apparatuses or apparatus parts, even on prolonged use, independently of whether the procedure is carried out in the reactor in an aqueous medium, in lipophilic solvents or in suspensions or emulsions with or without the use of emulsifiers. The novel apparatuses and apparatus parts are very suitable for carrying out chemical reactions, in particular for the polymerization of olefins, or for processing polymers.

The present invention furthermore relates to sanitary installations, fittings, swimming pools, shower cubicles, catheters and medical vessels, for example bags for donated blood, which have surfaces treated according to the invention. They prove particularly hygienic because neither viruses or fungi nor bacteria can settle on them.

The present invention furthermore relates to wooden articles, for example furniture or wood facades, having surfaces according to the invention. It was observed that they cannot be wet by water and are thus protected from rotting for a particularly long time.

The present invention furthermore relates to woven textile fabrics and leather whose surface has been finished by the novel process. They are particularly water-repellent and dirt-repellent. Moreover, the high transparency of the surfaces coated according to the invention ensures that colors and prints are particularly well displayed.

The present invention furthermore relates to filter materials and separation membranes, for example for the chloralkali electrolysis, having surfac s treated according to the invention.

The present invention furthermore relates to papers, board and cardboard boxes having surfaces treated according to the invention. They prevent softening in the presence of moisture and reduce the soiling. Examples of special cases of papers are bills and official documents, for the coating of which the novel process is particularly suitable. Owing to the high transparency of the surfaces coated according to the invention, it is furthermore ensured that colors and prints are particularly well displayed.

### WORKING EXAMPLES

### Example 1

A glass sheet was coated with an aqueous dispersion of a copolymer constisting of ethylene and acrylic acid (Lugalvan® DC, BASF AG) using a knife coater having a gap of 50 μm and was dried for 15 minutes in room air.

The coated side of the glass sheet was then dusted over the whole surface with a powder consisting of a silica pigment rendered hydrophobic and having a BET surface area of 220 m²/g (DIN 66131), by distributing the particles through a sieve over the surface, and was stored at 2 hours at 20° C. The coated side was then blown off with compressed air. An optically completely transparent coat was obtained, which showed no opacity at all when viewed in transmitted light.

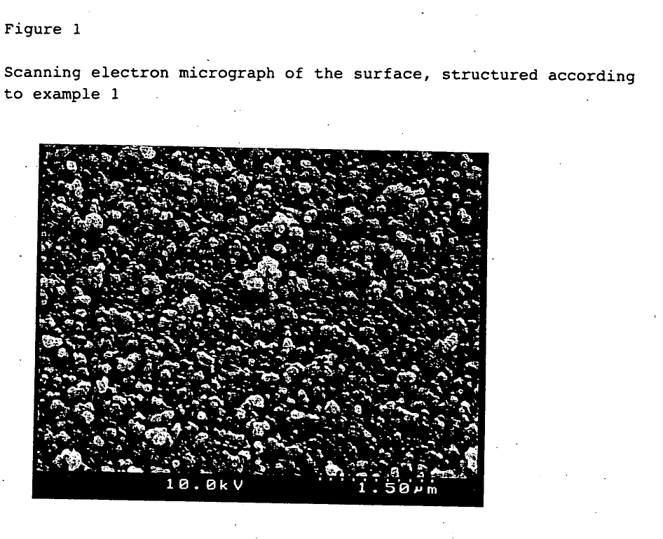

FIG. 1 shows a scanning electron micrograph of the coat produced according to the example.

### Example 2

A glass sheet was coated as described in example 1. In contrast to example 1, the glass sheet was stored for 2 hours at 40° C. after the powder coating. The coated glass sheet was likewise optically completely transparent and showed no opacity at all when viewed in transmitted light.

### COMPARATIVE EXAMPLE

A glass sheet was coated as described in example 2. In contrast to example 2, the glass sheet was stored for 2 hours at 80° C. after the powder coating. The coated glass sheet was optically not completely transparent. It showed slight opacity when viewed in transmitted light.

Wettability Tests:

The coated glass sheets described in examples 1 and 2 were mounted on a flat table and inclined 2° relative to the horizontal. The following liquids were then applied in succession in defined amounts and in the form of drops:

water (30 mg)

coffee (30 mg)

honey (59 mg)

glycerol (49 mg)

32% strength by weight aqueous hydrochloric acid (41 mg)

5% strength by weight aqueous sodium hydroxide solution (45 mg)

30% strength by weight aqueous solution of polyacrylic acid (47 mg)

30% strength by weight aqueous solution of a copolymer consisting of vinylpyrrolidone and vinylimidazole (35 mg)

aqueous polymer dispersion Acronal 290 D (BASF AG, 58 mg)

aqueous polymer dispersion Styronal D 808 (BASF AG, 46 mg)

At an angle of inclination of 2°, all liquids were repelled by the coated glass sheets from examples 1 and 2 and left no residues.

In a comparative experiment, the abovementioned liquids were applied to a glass sheet which had been coated only with the copolymers consisting of ethylene and acrylic acid but not with silica pigment which had been rendered hydrophobic. The angle of inclination of the glass sheet was likewise 2° relative to the horizontal. In all cases, wetting occurred; with the exception of water, all liquids left residues on the glass sheet.

The static contact angle of the coated glass sheets from examples 1 and 2 with respect to water is greater than 160°.

Testing of Dirt Removal:

The coated glass sheets from examples 1 and 2 were soiled with 100 mg/cm² of carbon black powder (Printex V from Degussa-Hüls AG, mean particle diameter of the primary particles: 25 nm) and then washed off with water. The carbon black powder was removed by the repelled water drops so that the original clean surface was cleaned again without the use of cleaning agents.

We claim:

1. A process for the dirt-repellent treatment of surfaces, which comprises coating the surfaces with particles which have a mean diameter of from 3 nm to 5 μm and consist of a material which has a surface energy of at least 20 mN/m and is selected from organic polymers and copolymers and solid inorganic oxides, carbonates, phosphates, silicates or sulfates of groups 3 to 14 of the Periodic Table.

2. A process as claimed in claim 1, wherein the particles have a mean diameter of from 7 nm to 0.5 μm.

3. A process as claimed in claim 1 or 2, wherein the particles have a porous structure.

4. A process as claimed in any of claims 1 to 3, wherein the surface to be provided with the dirt-repellent treatment is rendered tacky prior to coating.

5. A process as claimed in any of claims 1 to 4, wherein the surface to be provided with the dirt-repellent treatment is coated with a primer selected from adhesives, hotmelt adhesives and polymer dispersions and is then coated with particles.

6. A process as claimed in any of claims 1 to 4, wherein the plastics surface to be provided with the dirt-repellent treatment is heated to above the glass transition temperature or is superficially dissolved or swelled with a solvent and is then coated with particles.

7. A surface provided with the dirt-repellent treatment and having high transparency, obtainable by a process as claimed in claims 1 to 6.

8. A pipe or pipeline having surfaces provided with the dirt-repellent treatment, as claimed in claim 7.

9. A vessel or packaging having surfaces provided with the dirt-repellent treatment, as claimed in claim 7.

10. A motor vehicle having no tendency to icing or soiling which has surfaces provided with the dirt-repellent treatment, as claimed in claim 7.

11. The use, in plants, of apparatuses or apparatus parts, in particular inspection windows, having surfaces provided with the dirt-repellent treatment, as claimed in claim 7.

12. A sanitary installation, fitting, swimming pool, shower cubicle, catheter or medical vessel having surfaces provided with the dirt-repellent treatment, as claimed in claim 7.

13. A wooden article having surfaces provided with the dirt-repellent treatment, as claimed in claim 7.

14. A woven textile fabric or leather having surfaces provided with the dirt-repellent treatment, as claimed in claim 7.

15. A filter material or separation membrane having surfaces provided with the dirt-repellent treatment, as claimed in claim 7.

16. A paper, board or cardboard box having surfaces provided with the dirt-repellent treatment, as claimed in claim 7.
